(19) United States
(12) Patent Application Publication
(10) Pub. No.: US 2011/0283967 A1
(43) Pub. Date: Nov. 24, 2011

(54) HEAVY PARTICLE OIL SEPARATOR SPLASH SHIELD

(76) Inventors: DALE A. DEVOS, Orland Park, IL (US); Michael B. Goetzke, Orland Park, IL (US)

(21) Appl. No.: 13/111,901

(22) Filed: May 19, 2011

Related U.S. Application Data
(60) Provisional application No. 61/346,091, filed on May 19, 2010.

(51) Int. Cl. F01M 11/00; B23P 17/00

(52) U.S. Cl. 123/196 R; 29/888

(57) ABSTRACT

The present disclosure generally relates to a locomotive diesel engine and, more particularly, to a heavy particle oil separator splash shield. Specifically, provided is a system and method for reducing exhaust particulate emissions. The present shield minimizes heavy particle oil droplets in close proximity to the oil separator from entering the filter. As a result, the present shield minimizes saturation of the oil separator, thereby increasing the efficiency of the oil separator and reducing environmental pollution.

### CROSS-REFERENCE TO RELATED APPLICATIONS

This application is a Nonprovisional Patent Application, which claims benefit to U.S. Provisional Application Ser. No. 61/346,091, entitled “Heavy Particle Oil Separator Splash Shield,” filed May 19, 2010, the complete disclosure thereof being incorporated herein by reference.

### BACKGROUND OF THE DISCLOSURE

The present disclosure relates to reduction in exhaust particulate emissions from a locomotive diesel engine, and specifically to a heavy particle oil separator splash shield.

Oil separators are designed to trap and recover small oil droplets and particulate matter from vapors emitted from engines. Specifically, the crankcase ventilation oil separator is used to prevent the build-up of combustible gases in the crankcase, by collecting oil and particulate matter from vapors.

Cam shaft drive gears and counterweights are generally located in close proximity to the passage leading to the oil separator. The cam shaft drive gears are lubricated through a system of oil passages within the crankcase and manifolds which mount or connect to the mounting shafts for the gears. Oil passing through the gears is splashed around and on to the gears to create the necessary lubrication between the mating gear teeth. This splashing causes liquid oil droplets to enter directly into the passage to the oil separator from the crankcase. The purpose of the oil separator is to collect oil and particulate matter from vapors that pass through its element. Therefore, additional oil splashed into the separator from the cam shaft drive gears decreases the efficiency of the element of the oil separator, thus allowing more particulate matter to be released into the atmosphere.

Thus, it is an object of the present disclosure to provide a shield between the moving parts of the engine (including the cam shaft drive gears) and the oil separator filter to prevent heavy particulate oil droplets from saturating the oil separator. Specifically, the present shield minimizes heavy particle oil droplets in close proximity to the oil separator from entering the filter, thus preventing saturation of the oil separator and increasing the efficiency of the oil separator. As a result, environmental pollution is reduced.

The following description is presented to enable one of ordinary skill in the art to make and use the disclosure and is provided in the context of a patent application and its requirements. Various modifications to the preferred embodiment and the generic principles and features described herein will be readily apparent to those skilled in the art. For instance, although described in the context of a two-stroke diesel engine, the present device may be employed in any diesel engine. Thus, the present disclosure is not intended to be limited to the embodiments shown, but is to be accorded the broadest scope consistent with the principles and features described herein.

### SUMMARY

The present disclosure generally relates to a locomotive diesel engine and, more particularly, to a heavy particle oil separator splash shield. Specifically, provided is a system and method for reducing exhaust particulate emissions. The present shield minimizes heavy particle oil droplets from the cam shaft drive gears from entering the oil separator. As a result, the present shield minimizes saturation of the oil separator, thereby increasing the efficiency of the oil separator and reducing environmental pollution.

### BRIEF DESCRIPTION OF THE DRAWINGS

FIG. 1 is a perspective view of a locomotive.

FIG. 2 is a system diagram of a locomotive diesel engine having a conventional air system.

FIG. 3 is a partial cross-sectional view of the locomotive diesel engine of FIG. 2.

FIG. 4 is a cross-sectional view of a positive pressure zone of a diesel engine.

FIG. 5 is a cross-sectional view of a negative pressure zone of a diesel engine.

FIG. 6 is a perspective view of the locomotive diesel engine of FIG. 3.

FIG. 7 is a perspective view of an oil separator assembly for a diesel engine.

FIG. 8 is another perspective view of an oil separator assembly for a diesel engine.

FIG. 9 is a perspective view of the mounting location of the present splash shield, between the oil separator and mounting flange on turbocharger housing.

FIG. 10 is a perspective view of an embodiment of the present splash shield.

FIG. 11 is another perspective view of the embodiment of the present splash shield of FIG. 10.

FIG. 12 is a front view of the embodiment of the present splash shield of FIG. 10.

FIG. 13 is a side view of the embodiment of the present splash shield of FIG. 10.

### DETAILED DESCRIPTION OF THE PREFERRED EMBODIMENTS

The present disclosure relates to reduction in exhaust particulate emissions from a locomotive diesel engine, and specifically to a heavy particle oil separator splash shield. The oil splash shield reduces the amount of heavy particle oil splashed from a cam shaft drive gear into the oil separator, thereby reducing engine exhaust particulate matter emissions.

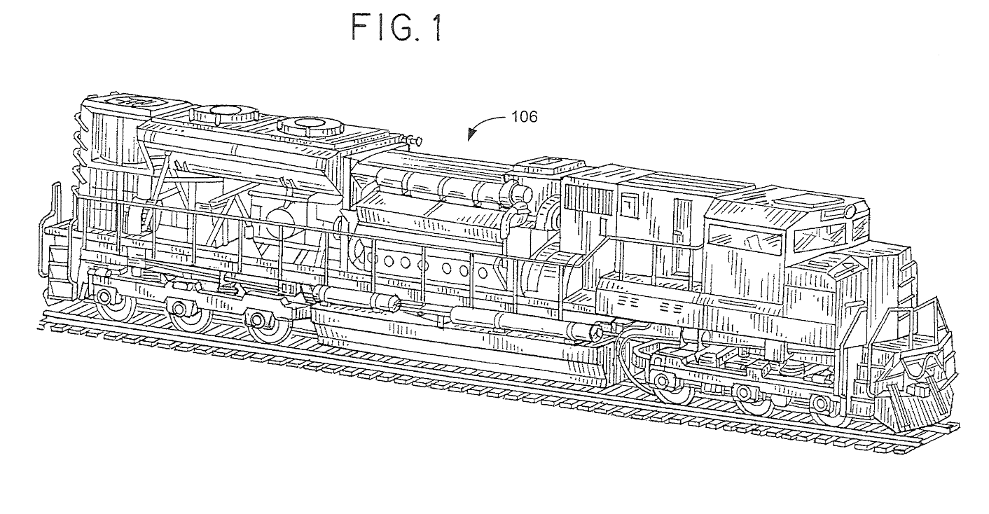

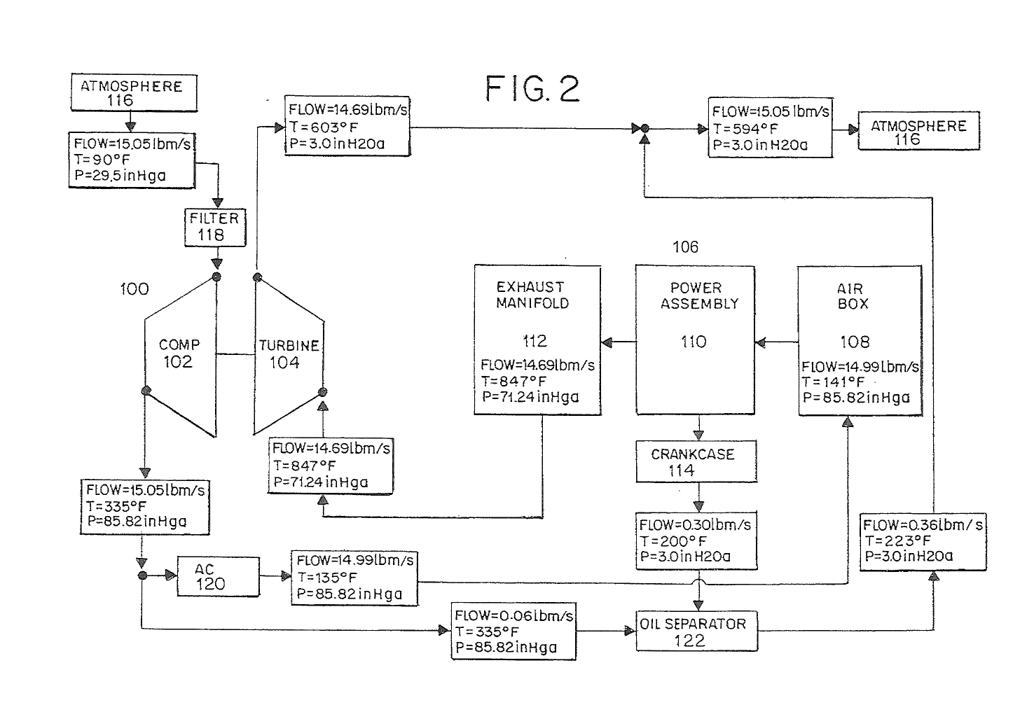

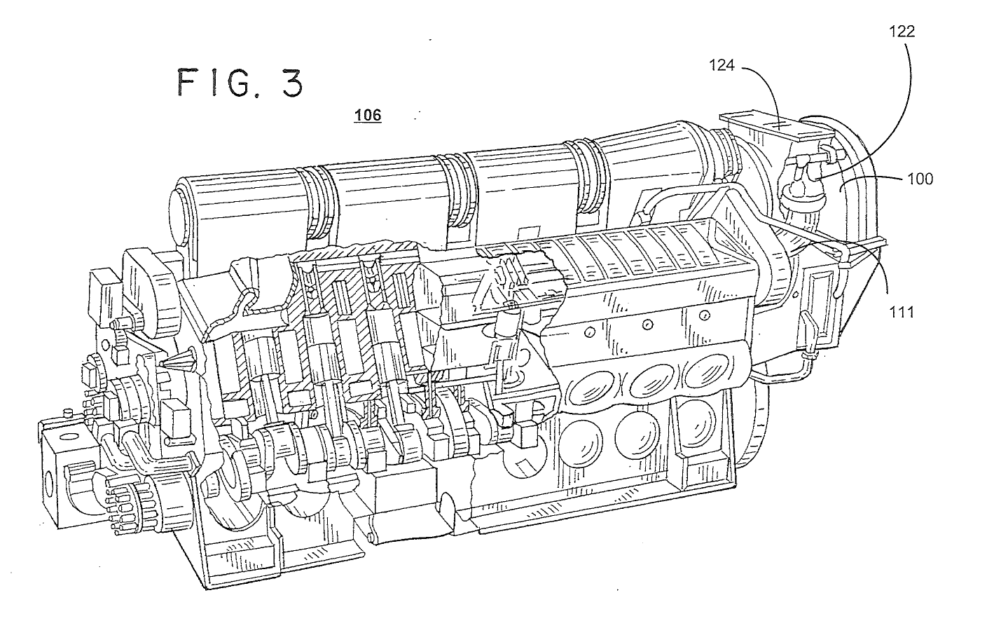

FIGS. 1-3 illustrate the present locomotive diesel engine generally comprising a turbocharger 100 having a compressor 102 and a turbine 104 which provides compressed air to an engine 106 having an airbox 108, power assembly 110, an exhaust manifold 112, and a crankcase 114. In a typical locomotive diesel engine, the turbocharger 100 increases the power capability of the engine 106 by pressurizing and increasing the amount of air transferred to the engine 106. More specifically, the turbocharger 100 draws air from the atmosphere 116 which is filtered using a conventional air filter 118. The filtered air is pressurized by a compressor 102. The compressor 102 is powered by a turbine 104. A larger portion of the compressed air is transferred to an aftercooler (or otherwise referred to as a heat exchanger, charge air cooler, or intercooler) 120 where the compressed air is cooled to a select temperature. Another smaller portion of the compressed air is transferred to a crankcase ventilation oil separator 122 (or otherwise referred to as an oil separator or lube oil separator) which evacuates the crankcase 114 in the engine 106, entrains crankcase gas and filters entrained crankcase oil before release into the atmosphere 116.

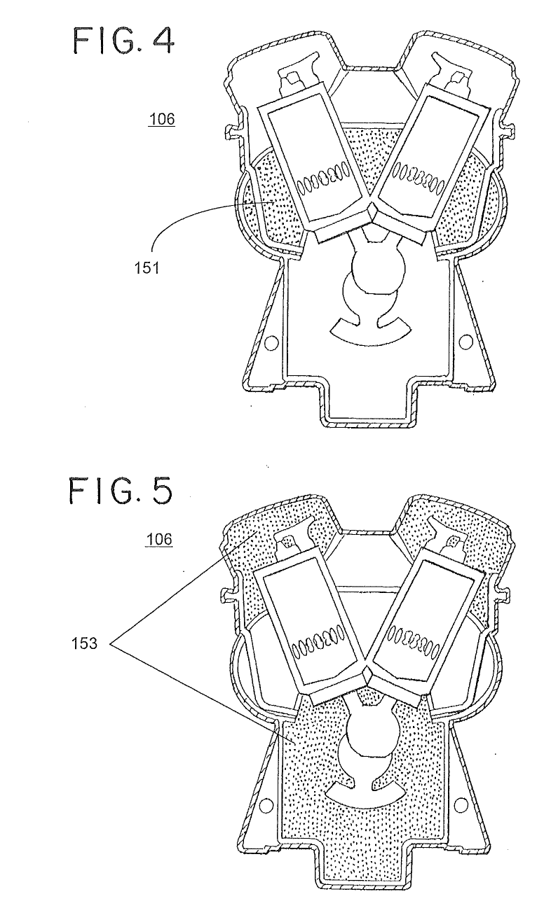

The engine 106 is divided into two distinct pressure zones: positive pressure 151 (above atmospheric pressure) and negative pressure 153 (below atmospheric pressure). The positive pressure zone 151 of a diesel engine is illustrated in FIG. 4, whereas the negative pressure zone 153 of a diesel engine is illustrated in FIG. 5. The engine 106 may include an eductor system to keep the crankcase 114 at a negative pressure whenever the engine is running. The top deck area of the engine is common to the engine sump through oil drain tubes, and the entire assembly is kept at negative pressure. Blower-equipped engines draw the crankcase 114 vapors through an oil separator 122 into the blower inlet. Turbocharger-equipped engines use an eductor (venturi) tube in the exhaust stack to draw the vapors through the oil separator 122 and expel them into the atmosphere.

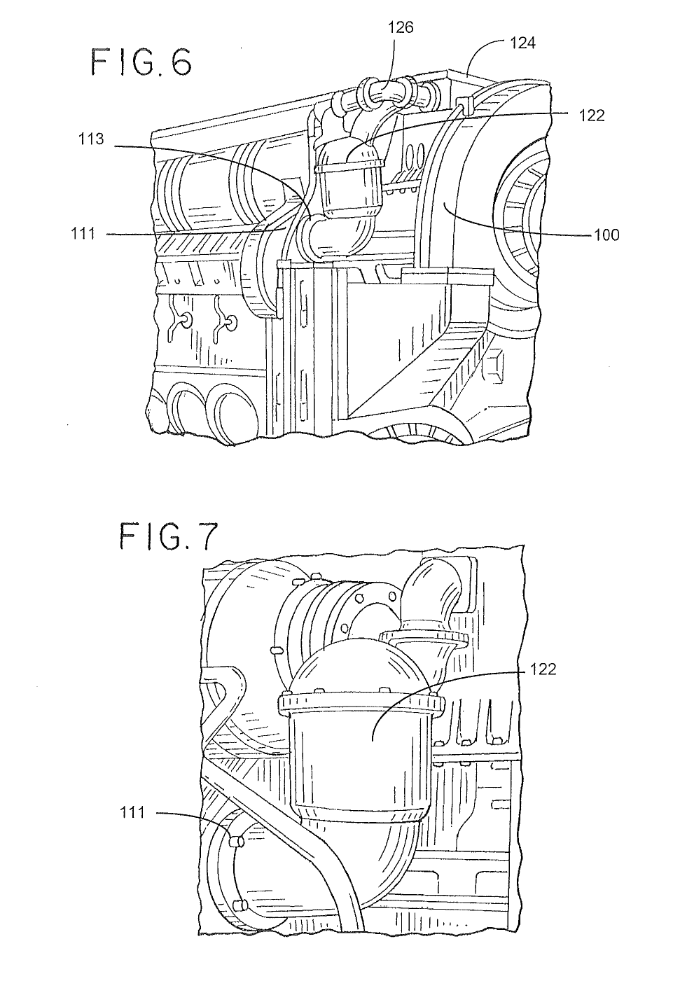

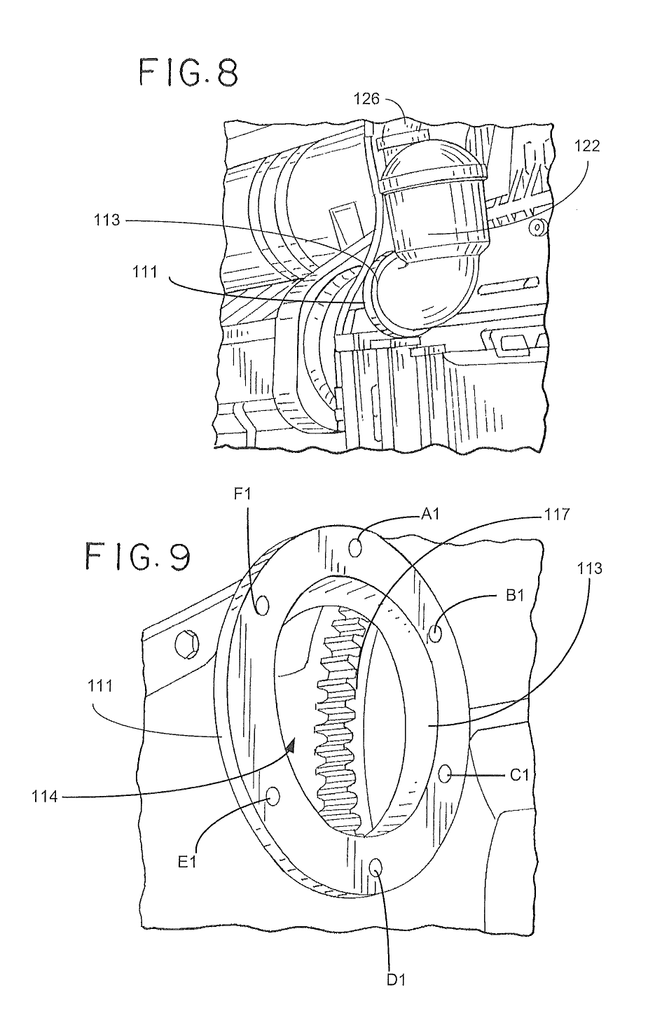

The oil separator 122 is generally configured to trap and recover small oil droplets and particulate matter carried out through vapors from the crankcase. Specifically, the crankcase ventilation oil separator 122 is used to prevent the build-up of combustible gases in the crankcase, by collecting oil and particulate matter from the vapors that flow through it. As shown in FIGS. 6-8, in this embodiment, the oil separator 122 generally includes an elbow-shaped cylindrical housing containing a wire mesh screen element (not shown). However, any type of oil separator may be used. The oil separator is mounted on the turbocharger mounting flange 111. An elbow assembly connects the oil separator 122 to the eductor tube assembly 126 in the exhaust stack 124. The eductor tube 126 in the exhaust stack 124 creates a suction which draws up vapor from the crankcase through the separator element. The oil and particulate matter collects on the element and drains back to the crankcase. The remaining gaseous vapor, generally free of oil and particulate matter, is discharged into the exhaust and vented to the atmosphere.

As described above, and further illustrated in FIG. 9, cam shaft drive gears 117 and counterweights are generally located in close proximity to the passage 113 leading to the oil separator 122. The cam shaft drive gears 117 are lubricated through a system of oil passages within the crankcase and manifolds which mount or connect to the mounting shafts for the gears. Oil passing through the gears 117 is splashed around and on to the gears 117 to create the necessary lubrication between the mating gear teeth. This splashing causes liquid oil droplets to enter directly into the connection joint or passage 113 to the oil separator, which contaminates and saturates the element of the oil separator 122 more quickly and more heavily. The purpose of the oil separator 122 is to collect oil and particulate matter from vapors that pass through its element. Therefore, additional oil splashed into the separator from the cam shaft drive gears decreases the efficiency of the element of the oil separator 122, thus allowing more particulate matter to pass through with the vapors and into the atmosphere.

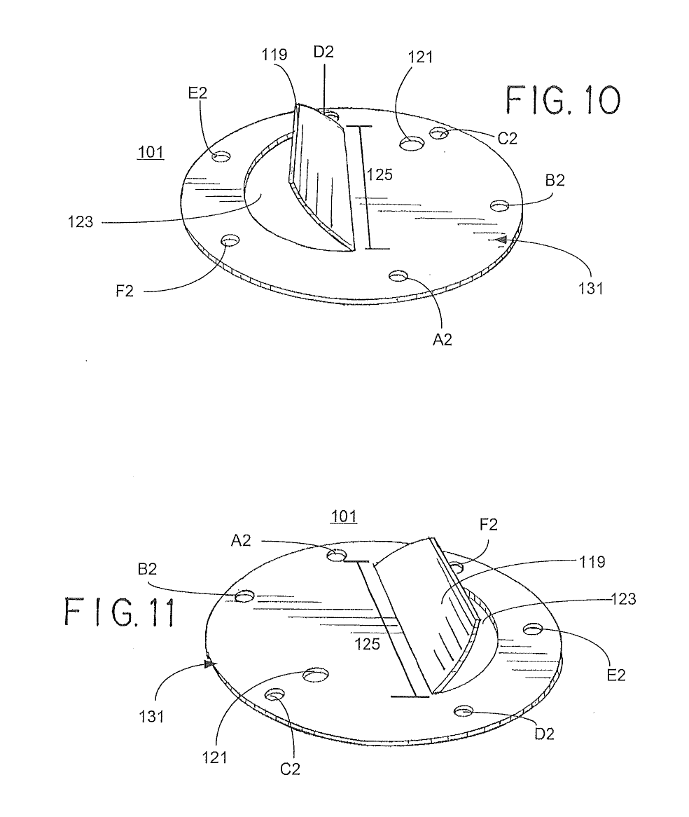

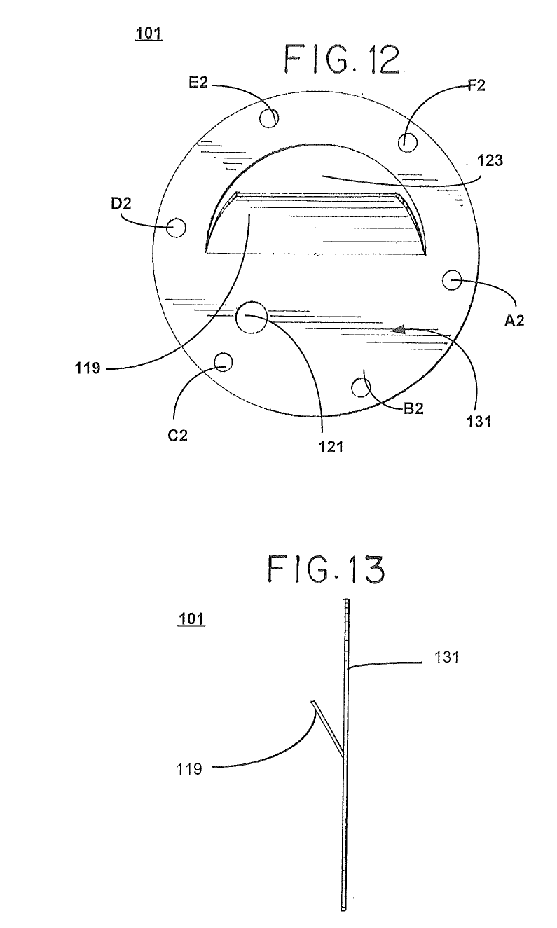

In the present system, an oil splash shield 101 is provided from minimizing transfer of heavy oil droplets from the cam shaft drive gears 117 to the oil separator 122 of the locomotive diesel engine (e.g., as shown in FIGS. 10-13). In this system, the engine 106 includes a passageway 113 for allowing vapor to flow from the crankcase 114 to the oil separator 122 for filtration. The oil splash shield 101 is positioned in the passageway 113 between the crankcase 114 and oil separator 122 such that the shield deflects splashing heavy oil droplets from the cam shaft drive gears 117 away from the oil separator 122. More specifically, the shield 101 is situated between the oil separator 122 and the mounting flange 111 of the turbocharger 100. This placement of the shield 101 generally prevents heavy particle oil droplets, splashed from the engine, from contaminating and saturating the oil separator 122 element.

In one embodiment, illustrated in FIGS. 10-13, the present shield 101 is comprised of a selectively shaped member 131 having a plurality of apertures (123 and A2 through F2) defined therein. In this embodiment, the member is in the shape of the plate. More specifically, the member 131 defines a larger aperture 123 in relation to a splash guard 119. The splash guard 119 is situated in relation to the moving parts of the engine (e.g. the cam shaft drive gears 117) such that it prevents flow of heavy particle oil droplets into the oil separator 122. Specifically, the splash guard 119 extends into the passage 113 between the crankcase and the oil separator 122, in line with the mounting flange 111 of the turbocharger 100. When the member 131 is mounted to the mounting flange 111, the length 125 of the splash guard 119 is generally oriented vertically and therefore in relation to the cam shaft drive gears 117. Moreover, the shield 101 is situated such that the mounting apertures (A2 through F2) defined in the shield 101 correspond to the mounting apertures (A1 through F1) defined in the mounting flange 111.

The larger aperture 123 defined in the shield 101 provides a passage for vapor from the crankcase 114 to flow to the oil separator 122. The larger aperture 123 is sized and shaped such that vapor flow is maintained from the crankcase 114 to the oil separator 122. Additionally, the larger aperture 123 is sized and shaped such that the efficiency of the oil separator 122 is not compromised by the presence of the shield 101. Thus, the splash guard 119 prevents heavy particle oil droplets from saturating the element, while the larger aperture allows vapor to enter the oil separator 122. Because the oil separator 122 element is not oversaturated with extraneous heavy particle oil droplets from the cam shaft drive gear 117, it is able to more efficiently separate oil from the passing vapor. As a result, particulate emissions are reduced.

Additionally, the shield 101 may further include a drain hole 121, as illustrated in FIGS. 10-13. As the oil separator 122 collects oil from the vapor, oil droplets collect in the oil separator 122. The drain hole 121 defined in the shield 101 allows this collected oil to drain out of the oil separator 122 and back into the crankcase 114. Therefore, it is preferable that the oil drain hole be defined on the bottom portion of the member to allow oil to drain more easily.

In applications that cause back pressure in the exhaust system, such as exhaust silencers or extended exhaust piping runs, an air ejector system is used to increase crankcase vacuum. In this system, pressurized air from the left bank aftercooler duct is piped to the ejector, where it blows through a venturi, adding to the suction created by the eductor tube. Different size ejector nozzles may be used to aid in maintaining proper crankcase suction levels. To increase crankcase suction, a large diameter nozzle is applied, after the engine is inspected for other causes of low vacuum. Oil droplets and particulate matter collect in the oil separator, and drain back to the crankcase, while the vapors discharge, generally free of oil and particulate matter, into the exhaust and are vented to the atmosphere.

The present system and method have been described in accordance with the embodiments shown, and one of ordinary skill in the art will readily recognize that there could be variations to the embodiments, and any variations would be within the spirit and scope of the present disclosure. Accordingly, many modifications may be made by one of ordinary skill in the art without departing from the spirit and scope of the appended claims.

1. An oil splash shield for minimizing transfer of oil droplets from a cam shaft drive gear of a crankcase to an oil separator in a locomotive diesel engine, wherein the engine includes a passageway for allowing vapor to flow from the crankcase to the oil separator, wherein the oil separator is configured to separate particulate matter and oil from vapors emitted from the crankcase, said oil splash shield comprising:
a plate positioned within said passageway, said plate having a crankcase facing side and an oil separator facing side, said plate further defining an aperture for allowing vapors to flow from the crankcase to the oil separator, and
a splash guard positioned in relation to said aperture on the crankcase facing side of the member for shielding oil droplets from the cam shaft drive gear from entering the oil separator via the aperture.

2. The oil splash shield of claim 1 further defining a second aperture for draining excess oil from the oil separator into crankcase.

3. The oil splash shield of claim 1 wherein the engine further includes a turbocharger having a mounting flange defining a plurality of mounting apertures therein.

4. The oil splash shield of claim 3 wherein said plate further defines a plurality of mounting apertures corresponding to the mounting apertures of the mounting flange for mounting the oil splash shield onto the mounting flange of the turbocharger.

5. The oil splash shield of claim 1 wherein the length of the guard is oriented vertically in relation to the cam shaft drive gear.

6. The oil splash shield of claim 1 wherein the splash guard extends into said passage and is positioned near the cam shaft drive gear.

7. A method for reducing exhaust particulate emissions from a locomotive diesel engine having a conventional air system by minimizing transfer of oil droplets from a cam shaft drive gear of a crankcase to an oil separator of the engine, wherein the engine includes a passageway for allowing vapor to flow from the crankcase to the oil separator, wherein the oil separator is configured to separate particulate matter and oil from vapors emitted from the crankcase, the method including the steps of:
providing a selectively shaped member within said passageway between the crankcase and the oil separator, said member having a crankcase facing side and an oil separator facing side, said member further defining an aperture for allowing vapors to flow from the crankcase to the oil separator, and
situating a splash guard on the crankcase facing side of the member for shielding oil droplets from the cam shaft drive gear from entering the oil separator, and further situating the guard in relation to said aperture for preventing oil droplets from the cam shaft drive gear from entering the oil separator via the aperture.

8. The method of claim 7 further including the step of defining an aperture in the selectively shaped member for allowing vapors to flow from the crankcase to the oil separator.

9. The method of claim 8 further including the step of situating the splash guard in relation to said aperture for preventing at least some of the oil from the cam shaft drive gear from entering the oil separator.

10. The method of claim 7 further including the step of draining excess oil from oil separator into engine.

11. The method of claim 7 further including the step of mounting the selectively shaped member between the crankcase and oil separator via corresponding mounting apertures defined in the selectively shaped member and a mounting flange.

12. The method of claim 7 further including the step of situating the splash guard vertically in relation to the cam shaft drive gear.

13. An oil splash shield for minimizing transfer of oil droplets from a cam shaft drive gear of a crankcase to an oil separator in a locomotive diesel engine, wherein the engine includes a passageway for allowing vapor to flow from the crankcase to the oil separator, wherein the oil separator is configured to separate particulate matter from vapors emitted from the crankcase, said oil splash shield comprising:
a selectively shaped member positioned between the oil separator and the crankcase of the engine, said member defining an aperture for allowing vapors to flow from engine to the oil separator, and
a splash guard situated in relation to said aperture for minimizing heavy particle oil from the cam shaft drive gear from entering the oil separator.

14. The oil splash shield of claim 13 further defining a second aperture for draining excess oil from the oil separator into crankcase.

15. The oil splash shield of claim 13 wherein the engine further includes a turbocharger having a mounting flange defining a plurality of mounting apertures therein.

16. The oil splash shield of claim 15 wherein said plate further defines a plurality of mounting apertures corresponding to the mounting apertures of the mounting flange for mounting the oil splash shield onto the mounting flange of the turbocharger.

17. The oil splash shield of claim 13 wherein the length of the guard is oriented vertically in relation to the cam shaft drive gear.

18. The oil splash shield of claim 13 wherein the splash guard extends into said passage and is positioned near the cam shaft drive gear.
